(19) United States
(12) Patent Application Publication
(10) Pub. No.: US 2017/0132318 A1
(43) Pub. Date: May 11, 2017

(54) METHOD, SYSTEM, AND DEVICE FOR ITEM SEARCH

(71) Applicant: Alibaba Group Holding Limited, Grand Cayman (KY)

(72) Inventors: Yazhuo Xu, Hangzhou (CN); Xuqian Lin, Hangzhou (CN)

(21) Appl. No.: 15/344,277

(22) Filed: Nov. 4, 2016

(30) Foreign Application Priority Data
Nov. 6, 2015 (CN) 201510753698.9

(51) Int. Cl. G06F 17/30

(52) U.S. Cl. CPC G06F 17/30713; G06F 17/30705

(57) ABSTRACT

An item search method is disclosed. The method may comprise storing one or more first terms and associated one or more second terms, receiving a first search phrase, determining a target first term of the one or more first terms, the target first term associated with the first search phrase, providing a second term associated with the target first term as a candidate term, and when a candidate term is selected by a user, determining the candidate term as a second search phrase, and providing a search result associated with the second search phrase.

### CROSS REFERENCE TO RELATED APPLICATION

The present application is based on and claims the benefit of priority to Chinese Application No. 201510753698.9, filed Nov. 6, 2015, the entire contents of which are incorporated herein by reference.

### TECHNICAL FIELD

The present disclosure relates generally to on-line search, and more particularly, to methods, systems, and devices for item search.

### BACKGROUND

For online shopping at e-commerce websites, users usually search for sales items (e.g., merchandises, commodities, goods, services, deals, packages, tickets, and the like) to find if a certain item is on sale and/or details of the items. Such search function is known as an item search function. That is, the user can input a search phrase, and correspondingly, a system can return a search result corresponding to the search phrase. The search result is generally provided for the user in a form of an item list, so the user can select one or more items from the list, and perform operations such as viewing details, purchasing, and the like.

In the search process, users usually hope that a search engine can return a high-quality search result that closely matches with the user's request. However, the quality of the search result is not only related to the performance of the search engine, but also with the quality of the search phrase. In other words, the degree of precision of the search phrase may determine the quality of the search result. In an actual application, however, the user may not know how to select or choose a phrase in the search process, or could only input a broad term as the search phrase if the name, category, or other information of a specific item is unknown. For example, if a user wants to search for a certain succulent plant “white peony” and she forgets the name “white peony,” she may input “succulent plant” or “succulent” as a search phrase in a search bar. A returned search results may include many specific succulent plants, and the user has to browse through the returned results to find the “white peony” that she is looking for. The efficiency of such search may be relatively low.

In order to help users input higher-quality search phrases, existing technologies offer functions of “associating search phrases.” For example, if a user inputs “mountaineering,” associated search phrases such as “mountaineering bags,” “mountaineering shoes,” and “mountaineering sticks” can be recommended as a completed search phrase. In this way, if the user wants to search for the mountaineering stick, she can directly make a selection in a pull-down menu.

The existing technologies, however, generate the associated search phrases mainly through text matching. If a certain term (e.g., a phrase or a text description) is related with a search phrase input by the user, but the certain term and the search phrase do not share common words, it is impossible to determine that term as an associated search phrase, and the search result would be based on the phrase input by the user. Thus, the probability that the obtained search result matching with the user's request would often be very low. Therefore, improving the quality of the search result has become a technical challenge to those skilled in the art.

### SUMMARY

One aspect of the present disclosure is directed to an item search method. The method may comprise storing one or more first terms and associated one or more second terms, receiving a first search phrase, determining a target first term of the one or more first terms, the target first term associated with the first search phrase, providing a second term associated with the target first term as a candidate term, and when a candidate term is selected by a user, determining the candidate term as a second search phrase, and providing a search result associated with the second search phrase.

Another aspect of the present disclosure is directed to a method for establishing a term association relationship. The method may comprise receiving a search phrase input by a user and determining whether the search phrase matches a first term. If the determination is yes, the method may further comprise collecting operational behavior data of the user within a subsequent preset time period, wherein the first term is categorized, extracting one or more target terms in the operational behavior data, clustering the one or more target terms according to relations with the first term, and determining a target term that can be clustered with the first term as a second term associated with the first term.

Another aspect of the present disclosure is directed to an item search apparatus. The apparatus may comprise an association relationship storage unit configured to store one or more first terms and associated one or more second terms, a first search phrase receiving unit configured to receive a first search phrase, a determination unit configured to determine a target first term of the one or more first terms associated with the first search phrase, a candidate term providing unit configured to provide a second term associated with the target first term as a candidate term, and a search result providing unit configured to, when a candidate term is selected by a user, determine the candidate term as a second search phrase, and provide a search result associated with the second search phrase.

Another aspect of the present disclosure is directed to an apparatus for establishing a term association relationship. The apparatus may comprise an operational behavior data collection unit configured to, when a search phrase input by a user matches with a first term, collect operational behavior data of the user within a subsequent preset time period, wherein the first term is categorized, a target term extraction unit configured to extract one or more target terms in the operational behavior data, a clustering unit configured to cluster the target terms according to relations with the first term, and an association relationship determination unit configured to determine a target term that can be clustered with the first term as a second term associated with the first term.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a flow diagram illustrating a method for establishing a term association relationship, consistent with exemplary embodiments of the present disclosure.

FIG. 2 is a flow diagram illustrating a method for item search, consistent with exemplary embodiments of the present disclosure.

FIGS. 3A-3C are graphical representations illustrating methods for item search, consistent with exemplary embodiments of the present disclosure.

FIG. 4 is a block diagram illustrating a system for establishing a term association relationship, consistent with exemplary embodiments of the present disclosure.

FIG. 5 is a block diagram illustrating a system for item search, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Although existing technologies can suggest an associated term based on a user-input search phrase, such process is merely “word completion,” where the user inputs some words or characters as a part of the search phrase, and the remaining words can be completed by a prompt suggested by the system. For example, if the user wants to search for a “mountaineering stick,” after she inputs “mountaineering,” the system may suggest various terms associated with “mountaineering,” some of which may contain the “mountaineering stick.” Thus, the user may only need to select the “mountaineering stick” term from suggested terms without inputting the word “stick.” Such method is based on a condition that the user knows the exact phrase to search for, which does not always apply to actual applications. For example, the user may not know the exact name of the item that she is looking for online. The user may want to search for a certain succulent plant, but she forgets its name and has to use a relatively broad term such as “succulent” or “succulent plant” as a search phrase. After a search engine returns multiple search results about the search, the user has to identify the desired succulent plant from many more irrelevant succulent plants.

Thus, if the phrase input by the user is a relatively broad term (hereinafter referred to as “first term”), the probability that a generated search result matches with the user's request is very low. If a more precise term (hereinafter referred to as “second term”) can be provided to the user for selection after the user inputs the first term, the second term can be used as a search phrase to generate a better search result. Further, the first term and the second term may not be related by one or more common words or characters. For example, a first term is “succulent,” and the second term may include “Black prince,” “White peony,” “Alocasia,” and etc., which are unrelated in literal meanings. Therefore, with existing technologies, it is impossible to generate such second terms with the “word completion” method. In other words, in the prior art, if a search term input by the user is the first term, the system would not be able to generate a second term that does not share one or more common words or characters with the first term. For example, in the prior art, if the search phrase input by the user is “succulent,” an associated result suggested by the system may include “succulent plant,” “succulent flowerpot,” “succulent soil,” and so on, but would not include more precise terms such as “Black prince,” “White peony,” and “Alocasia.”

To improve the quality of the search result, according to the embodiments of the present disclosure, when a search phrase input by the user includes the first term, a more specific second term can be suggested, to prompt the user to select the second term as the search phrase. In the implementation process, since the first term and the second term may not share common words or characters, an association relationship between the first term and the second term can be established. In this way, when a user inputs a phrase, whether the phrase matches with a first term can be determined; and if yes, a second term associated with the first term can be suggested to the user by querying the established association relationships. By this method, even if the first term and the second term are not related with each other in text, it is possible to identify and suggest the second term to the user. Detailed methods and steps will be introduced below.

In some embodiments, at first, an association relationship between a first term and a second term can be established. The relationship can be manually established according to common experiences. Also, data mining can be used to establish the association relationship. When a user conducts a search, makes a selection from a search result, or conducts other related operation steps, relationships between first terms and second terms can be captured and stored from such user behavior data. For example, a certain user inputs a search phrase “succulent,” after the system returns a search result including multiple specific items, the user may select one of the items and perform an operation such as viewing details of the item by clicking. If the user finds that the item does not match with her request after checking the details, she may close the details page, go back to the original page of search results to browse other items, and so on. In addition, in the search process, it is also possible for the user to modify the search phrase to conduct another search. The reason for modifying the search phrase may be that the first search result does not contain any item that meets the user's request, or a new search is initiated, and etc. During such operations, the user behavior can be extracted, including corresponding first and second terms. For example, if a certain item in the search result is selected, the subject of the item name may be captured as the second term, while the original search phrase can be captured as the first term; if the search phrase is modified to conduct a new search, the modified search phrase may be captured as the second term, while the original search phrase can be captured as the first term. By capturing the terms corresponding to the user behavior data, it is possible to determine and store multiple association relationships between first terms and second terms. The data mining method is introduced below in more details.

A method for establishing a term association relationship is disclosed. In some embodiments, a first term can be categorized into a search scenario by manual annotation or other methods. The particular scenario may be a professional knowledge scenario, a current affair scenario, a holiday scenario, and the like. After the specific scenario is determined, it is feasible to annotate one or more first terms in the scenario. For example, under the professional knowledge scenario, annotated first terms may include “succulent,” “mountaineering,” and the like; and in the holiday scenario, annotated first terms may include “Valentine gift,” “Christmas gift,” and so on. For each scenario, if the user's search phrase is not precise enough, alternative first terms which the user may use to conduct the search can be predicted, and the alternative first terms can be annotated to the same scenario. After the annotation is completed, it is feasible to proceed to the data mining process.

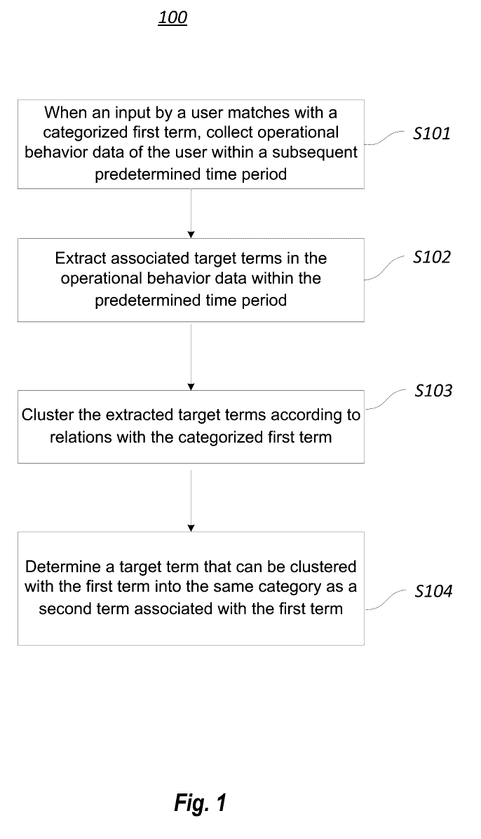

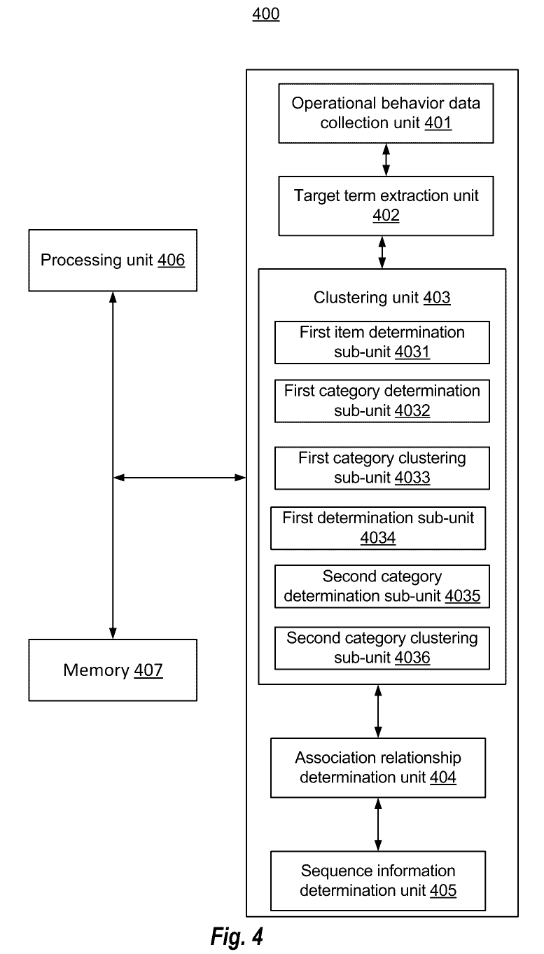

FIG. 1 is a flow diagram illustrating a method 100 for establishing a term association relationship, consistent with exemplary embodiments of the present disclosure. Method 100 may include the following steps, some of which may be optional. Method 100 may be performed by one or more components of system 400 described below with reference to FIG. 4.

At step S101, one or more components of system 400 may monitor search behavior data of a user, and when an input by the user matches with a categorized first term, collect operational behavior data of the user within a subsequent predetermined time period.

For example, one or more components of system 400 may receive a search phrase input by a user and determine whether the search phrase matches a first term. If the determination is yes, the one or more components of system 400 may collect operational behavior data of the user within a subsequent predetermined time period.

In the data mining process, it is feasible to collect data at first. The data collecting may be performed based on the categorized first term. That is, it is feasible to monitor search behavior data of a user. If a search phrase input by the user matches with a categorized first term (e.g., if the input search phrase includes the first term, or if a textual similarity between the search phrase and a certain first term reaches a certain threshold), from this time, operational behavior data of the user within a subsequent preset time period can be collected, and the behavior data may include a second term associated with the first term. The length of the subsequent preset time period may be determined according to actual applications, for example, 30 minutes or the like. The collected operational behavior data may include user operation steps related to selecting an item from a search result, and/or a new search initiated after the search phrase is modified.

In some embodiments, the user operation steps may have a sequential relationship, which can also reflect whether the terms are associated, the degree of association, and the like. For example, after a user input a certain search phrase, a sooner-performed operation step may have a closer association with the search phrase, while a later-performed operation step may have a weaker or zero association with the search phrase. Therefore, when the operational behavior data is collected, it is also possible to record an order between various operation steps, which is a sequence of occurrence of the user operation steps. In this way, when the terms are clustered subsequently, it is possible to take into account the order of the terms as a clustering factor. Details of the clustering are introduced in the following steps.

At step S102, one or more components of system 400 may extract associated target terms in the operational behavior data within the predetermined time period.

After the operational behavior data of the user is collected, it is possible to extract associated target terms therefrom. For example, if the behavior data is selecting an item from a search result, it is possible to extract the subject of the name of the selected item from its description information as an associated target term in the operational behavior data. For example, a user inputs a search phrase “succulent,” which matches with a categorized first term, and it is found in the collected operational behavior data that the user selects several items in the search result to view details, and that the user first selects a certain item, of which the name description is “a succulent plant of a certain brand, Black prince, mini office plant potted flower, small desktop bonsai.” It is possible to extract, from the name description, that the subject of the name description of the selected item is “Black prince.” It should be noted that, the name description of an item may be set by a merchant or a seller. In order to maximize matching with more search phrases, the name description of the item may be long and contain several phrases. Extracting the subject of the item from the name description may be implemented with existing technologies, which are not detailed herein.

In some embodiments, if the behavior data includes performing operation steps initiated after the search phrase is modified, the extracted target term may be the modified search phrase. For example, if a search input by the user for the first time is “succulent,” and then the search phrase is modified to “succulent plant,” it is possible to determine that, in the operational data, the associated target term is “succulent plant.” For another example, the modified search phrase may also be the name of a certain item, for example, “Black prince” or the like. For another example, the modified search phrase may also be completely irrelevant to the initial search phrase. In addition, after modifying the search phrase, the user may also select an item from a new search result for viewing and so on. Therefore, the operational behavior data may also include selecting an item in the new search result, and it is also possible to extract the subject of the name description of the selected item in the new search result as an associated target term of the new selection behavior. The extraction process is similar to the extraction process described above.

At step S103, one or more components of system 400 may cluster the target terms according to relations with the categorized first term.

After multiple target terms are collected, it is possible to cluster (e.g., categorize) the target terms according to relations between the target terms and the categorized first term. There may be lots of clustering methods. For example, it is possible to perform clustering based on an item category. If the operational behavior data is selecting an item in a search result, correspondingly, the target term may be a subject of the selected item. Since category information may be predetermined for each item on a transaction platform system (e.g., the item may be designated and released to a certain specific category to offer to online customers), the category of the selected item can be determined. Therefore, for such target term, it is possible to first determine a selected target item associated with the target term, and then determine the category of the target item as the category of the corresponding target term. For example, if a certain selected item is “Black prince” of a certain merchant, the extracted target term is “Black prince.” At this point, the category of the item can be determined. For example, if the item is determined to belong to the category of “succulent plant,” the category of the target term “Black prince” can be determined as “succulent plant.” In addition, in order to perform clustering based on an item category, it is also possible to categorize the item associated with the first term when the first term is categorized. For example, for the first term “succulent,” the category of the items associated therewith may be “succulent plant,” “succulent soil,” “succulent flowerpot,” and so on. In this way, when the clustering is performed based on a category, it is feasible to determine whether the category of the target term is the category of the item associated with the first term. If yes, it is feasible to cluster the target term and the first term into the same category. For example, if a first term input by the user is “succulent,” an item of which the subject of the name description is “Black prince” is selected in the search result, and the item is determined to be a succulent plant, it is feasible to cluster the target term “Black prince” and the first term “succulent” into the same category.

In some embodiments, the behavior data collected may also include data of a new search initiated after the search phrase is modified, and correspondingly, the target term may include the modified search phrase as well as the subject extracted from description information of the item selected in a new search result. For such data, when clustering is performed, the search phrase may be modified for different reasons, which may affect whether the generated data is associated with the original first term. Thus, it is feasible to first determine the modified search phrase. For example, it is feasible to first determine whether the modified search phrase is an item name. If yes, it is likely that the modified search phrase directs to a more precise search target, which may be a clarification to the original first term after the user sees the original search result. It is also likely that the modified search phrase directs to other items completely irrelevant to the original first term. Therefore, it is possible to first determine the category of the item and then determine the category of the item to be the category of the corresponding target term. If the category of the target term belongs to the category of the item associated with the categorized first term, the target term and the first term may be clustered into the same category. Otherwise, if the category of the target term does not belong to the category of the item associated with the categorized first term, the user may have changed to search for other items not associated therewith, and thus the corresponding target term and the first term may no longer be clustered into the same category.

In some embodiments, if the modified search phrase is not the name of the item, it may suggest that the user is not satisfied with the original search result, hopes to improve the quality of the search result by modifying the search phrase, but still is not clear about the second term during the modification, so the user modifies the search phrase into another first term. For example, the original search phrase is “succulent,” and the search result includes “succulent plant,” “succulent flowerpot,” “succulent soil,” and other information, but the user actually only wants to search for a certain succulent plant, so the user modifies the search phrase to “succulent plant.” Another situation is that the user may change to search another item and the search target is still not precise, and thus the user may input another first term. For the former case, the search results from the new search may still be associated with the categorized first term, and thus, when selecting from the search results and other operations are performed, it is likely to generate a second term associated with the first term. For the latter case, in the search results after a new search is initiated, a second term associated with the original first term may not appear. If, after the search phrase is modified, the new search results obtained still have a second term associated with the original first term, the modified search phrase may also be associated with the original first term. Therefore, when clustering is performed, if it is found that the modified search phrase is not the name of the item, it is feasible to first cluster target terms generated in the behavior data of selecting from the new search results based on an item category, and then use the clustering result to determine whether the modified search phrase can be clustered into the same category with the original first term. For example, it is possible to determine a corresponding selected target item in the behavior data of selecting from the new search results and determine the category of the selected target item as the category of the corresponding target term(s). If the category of the target term belongs to the category of an item associated with the first term, the target term and the first term can be clustered into the same category, and it is also possible to cluster the modified search phrase and the first term into the same category.

For example, the search phrase input by the user for the first time is “haze removal,” which is a categorized first term to obtain search results, and then the user modifies the search phrase to “plant purification” to obtain an updated search results, and performs an item selection operation on updated search results. Upon analysis on the behavior data, it is found that, in the behavior data of selecting from the updated search results by the user, an extracted target term of the selected item can be clustered into the same category with the original first term “haze removal.” At this point, it is also possible to cluster the modified search phrase “plant purification” and “haze removal” into the same category. By this method, when the association relationship between the first term and the second term is mined, the second term may be a name of a specific item, or a term more precise than the first term, but not as precise as the name of the specific item.

In addition to clustering terms based on an item category, it is also possible to perform clustering based on semantic analysis or other methods, which are not detailed herein.

At step S104, one or more components of system 400 may determine a target term that can be clustered with the first term into the same category as a second term associated with the first term.

After clustering is completed, it is feasible to determine a target term that can be clustered with the first term into the same category as a second term associated with the first term. The operation of collecting the operational behavior data of the user can be performed for one or more users. However, when an operation such as clustering the terms is performed, it is possible to perform the operation based on data collected for each user each time, respectively, and then fuse each clustering result, to determine the second term associated with the first term. That is to say, if a certain user searches for different terms A, B, and C within a continuous period of time, and some other users all behave similarly, these terms can be clustered.

The above introduces the implementation methods of establishing an association relationship between the first term and the second term. After the association relationship is established, it is feasible to, in a process that the user conducts a search, determine whether the search phrase input by the user is the first term, and if yes, a corresponding second term can be provided for the user to make a selection, so that the user, after selecting a more precise term as a search phrase, can receive a better search result. The following introduces the process.

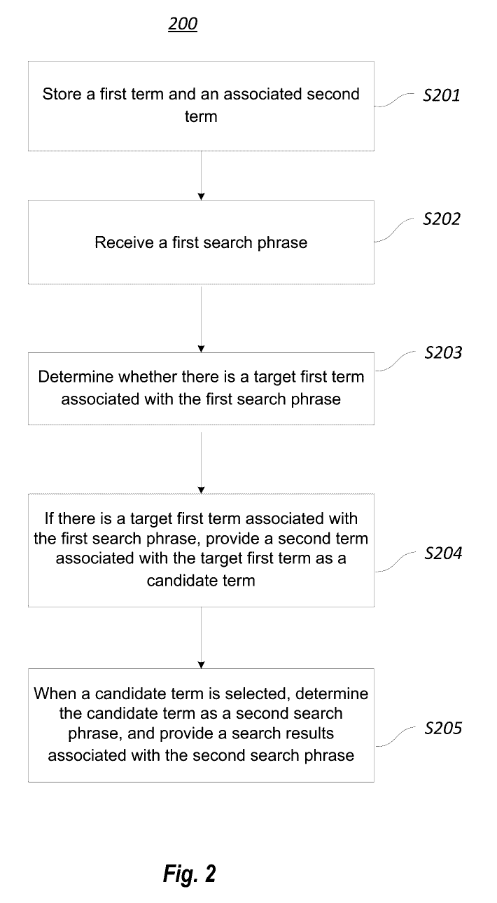

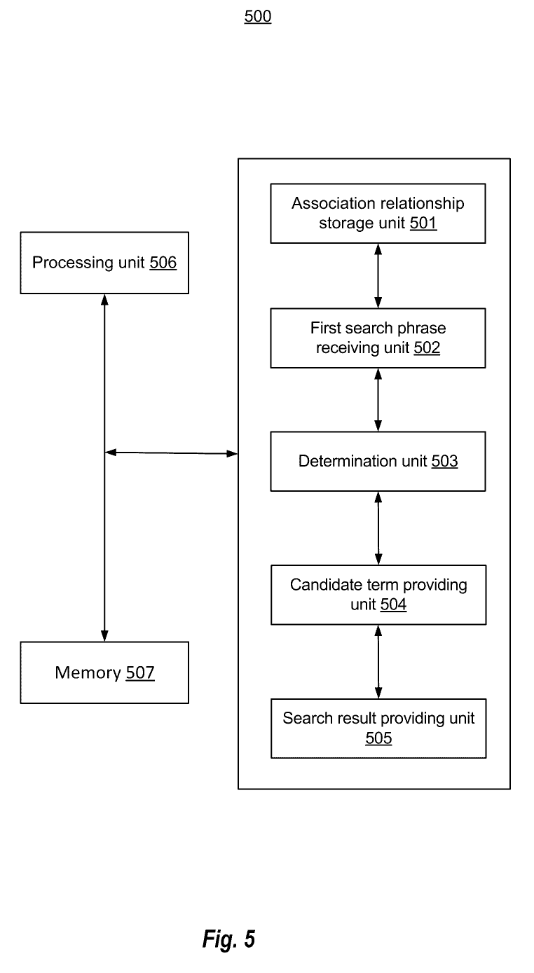

FIG. 2 is a flow diagram illustrating a method 200 for item search, consistent with exemplary embodiments of the present disclosure. Method 200 may include the following steps, some of which may be optional. Method 200 may be performed by one or more components of system 500 described below with reference to FIG. 5.

At step S201, one or more components of system 500 may store a first term and an associated second term.

As described above, the first term may be a term with a relatively broad meaning, and the second term may be a term with a relatively precise meaning. The first and the second terms may be associated as described above with reference to FIG. 1. The created association relationship may be stored in a server (e.g., a memory of a server), or may also be synchronized to a client terminal for storage, and be synchronously updated. Correspondingly, the server or the client terminal (e.g. a processor of the server or the client terminal) may implement method 200. The client terminal in this disclosure may refer to a terminal device, such as a computer or a cellphone.

At step S202, one or more components of system 500 may receive a first search phrase.

In some embodiments, the client terminal is used for performing human-computer interaction with a user, and thus the client terminal can receive a first search phrase input by the user. If method 200 is implemented by the client terminal, step S202 is receiving a first search phrase input by a user. If method 200 is implemented by the server, the client terminal may receive a first phrase input by a user and transmit the first search phrase to the server, so that the server receives the first search phrase submitted by the client terminal. Whether the client terminal or the server implements method 200, the client terminal and the server have not yet initiated a formal search request in step S202. That is, after inputting the first search phrase, the user has not yet clicked the “search” button, nor pressed a keyboard search shortcut such as “Enter.”

At step S203, one or more components of system 500 may determine whether there is a target first term associated with the first search phrase.

If method 200 is implemented by the client terminal, the client terminal may have stored an association relationship between the first term and the second term. The client terminal, after receiving the first search phrase, can directly determine whether there is a target first term associated with the first search phrase. For example, if the first search phrase is “succulent” and if it is determined that there is a first term “succulent” in the stored association relationship, it is possible to determine that the first search phrase input by the user is a first term. If method 200 is implemented by the server, a determination can also be made as described above after the first search phrase submitted by the client terminal is received.

At step S204, if there is a target first term associated with the first search phrase, one or more components of system 500 may provide a second term associated with the target first term as a candidate term.

If there is a first term associated with the first search phrase, it is possible to provide a second term associated with the target first term as a candidate term. If method 200 is implemented by the client terminal, it is possible to display the candidate term directly through a pull-down menu or in other methods. If method 200 is implemented by the server, it is possible to first return the candidate term to the client terminal and then display the candidate term by the client terminal.

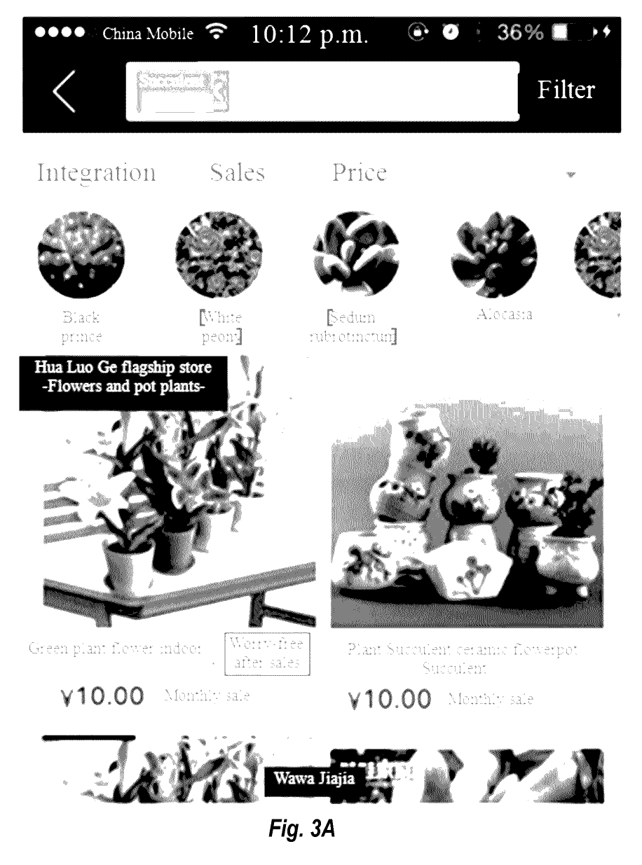

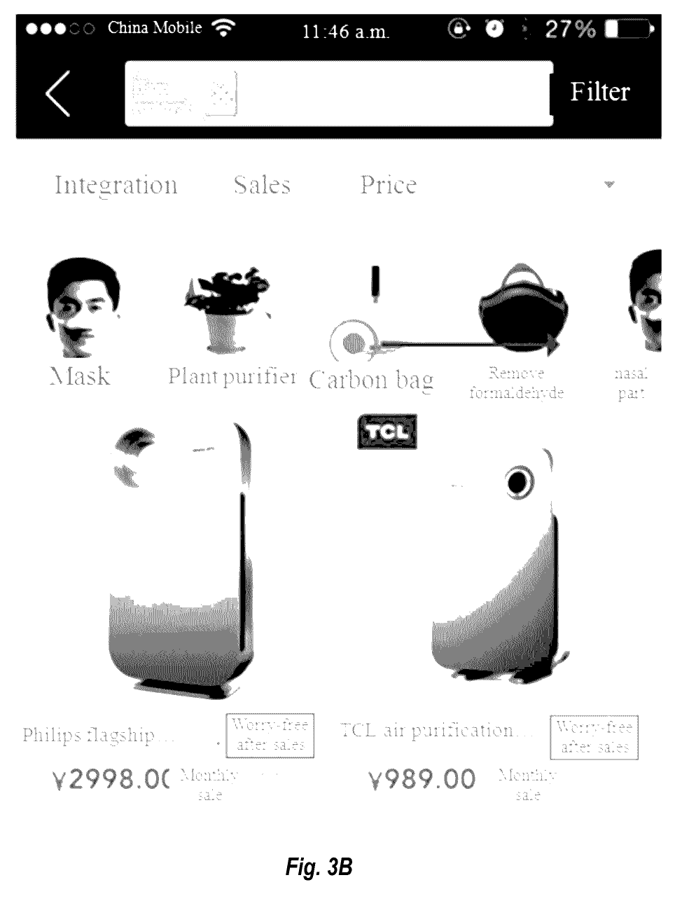

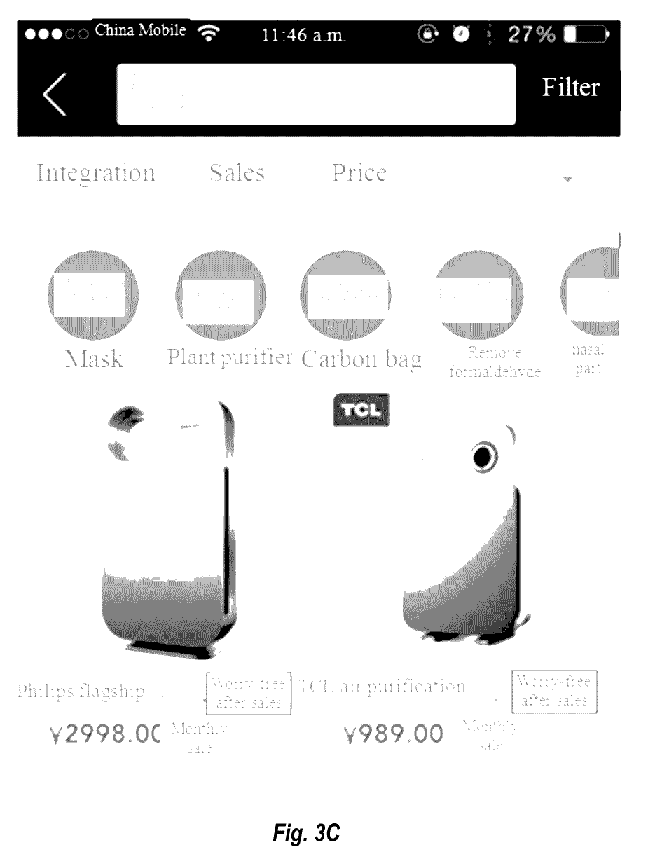

In some embodiments, in order to improve the effect of displaying the candidate term and also make it easy to draw the user's attention, it is possible to pre-store a corresponding display copy for each associated second term. In this way, when each candidate term is provided, it is also possible to provide such a display copy. For example, the display text may include a representative picture corresponding to the second term or the like, and a representative picture and a text description of the same second term can be displayed in the same position in a form of flip display or other display methods. For example, as shown in FIG. 3A, when the first search phrase input by the user is “succulent,” it is possible to provide the user with multiple second terms such as “Black prince” and “White peony,” and each second term further corresponds to its own representative picture, enabling the user to identify which second term better meets his or her request. For another example, as shown in FIG. 3B, when the first search phrase input by the user is “haze removal,” it is possible to provide the user with second terms such as “mask,” “plant purification,” and “carbon bag,” and each second term may also correspond to its own representative picture.

In addition, for some first terms of a hot topic or festival nature, it is also possible to pre-configure other copies for the second terms, for example, for “haze removal,” it is also possible to display the second terms as shown in FIG. 3C, where the representative pictures change into words, corresponding to “Under,” “the,” “Dome,” and so on, respectively. It is also possible to then flip these words into the representative pictures corresponding to the second terms.

S205: When a candidate term is selected, determine the candidate term as a second search phrase, and provide a search result associated with the second search phrase.

After a certain candidate term is selected, it is possible to determine the candidate term as a second search phrase, and provide a search result associated with the second search phrase. If method 200 is implemented by the client terminal, it is possible to send a search request to the server, the request carrying a second search phrase. After a search result returned by the server is received, it can be provided to the user. If method 200 is implemented by the server, the server may provide a search result to the client terminal, and then the client terminal may provide the search result to the user.

As described above, it is possible to pre-establish and store an association relationship between a first term and a second term. In this way, after a user performs a search operation and inputs a first search phrase, it is possible to determine whether there is a first term corresponding to the first search phrase. If yes, it is possible to provide the user with a second term associated with the first term, for the user to make a selection, such that the user can use the second term to initiate a search, and obtain a higher-quality search result. The disclosed methods can also increase the search efficiency, reduce the operation path of the user, and so on.

FIG. 4 is a block diagram illustrating a system 400 for establishing a term association relationship, consistent with exemplary embodiments of the present disclosure. System 400 may be a device for establishing a term association relationship, such as a mobile phone, a computing device, a tablet computer, a mobile multimedia playback device, a smart watch, and etc. System 400 may include a number of components, some of which may be optional. The components in FIG. 4 may be arranged in another order. System 400 may include, for example, a processing unit 406 and a memory 407. Memory 407 may be a non-transitory computer-readable storage medium storing instructions that, when executed by processing unit 406, cause one or more components of system 400 to perform the steps and methods described in this disclosure. System 400 may include functional modules implemented by the processing unit 406 and the memory 407, including, e.g., an operational behavior data collection unit 401, a target term extraction unit 402, a clustering unit 403, an association relationship determination unit 404, and a sequence information determination unit 405. Operational behavior data collection unit 401, target term extraction unit 402, clustering unit 403, association relationship determination unit 404, and/or sequence information determination unit 405 refer to or correspond to blocks of software code stored on memory 407. The processing unit 406 can execute the blocks of software code and perform the functions corresponding to the functional modules. The steps below are related to corresponding methods described above, and some details are not repeated.

Operational behavior data collection unit 401 may be configured to monitor search behavior data of the user, and when a search phrase input by a user matches with the categorized first term, collect operational behavior data of the user within a subsequent preset time period.

Target term extraction unit 402 may be configured to extract associated target terms in the operational behavior data within the preset time period.

Clustering unit 403 may be configured to cluster the target terms according to correlation with the first term.

Association relationship determination unit 404 may be configured to determine a target term that can be clustered with the first term into the same category as a second term associated with the first term.

In some embodiments, operational behavior data collection unit 401 may be further configured to collect behavior data of selecting items in a search result by the user within the subsequent preset time period, and target term extraction unit 402 may be further configured to extract, from description information of the items selected, one or more subjects of item names as the associated target terms in the operational behavior data.

The pre-annotated information may further include category information of an item associated with the first term, and clustering unit 403 may include:

a first item determination sub-unit 4301 configured to determine a selected target item corresponding to the operational behavior data;

a first category determination sub-unit 4302 configured to determine a category of the target item as a category of the corresponding target terms; and

a first category clustering sub-unit 4303 configured to, if the category of the target terms belongs to a category of the item associated with the first term, cluster the target terms and the first term into the same category.

In addition, operational behavior data collection unit 401 may be further configured to collect data in a new search behavior initiated by the user after modifying the search phrase within the subsequent preset time period, and collect behavior data of making a new selection on items in a new search result.

Target term extraction unit 402 may be further configured to determine the modified search phrase as an associated target term in the data of the new search behavior, and extract, from description information of the items selected from the new search result, one or more subjects of item names of associated target terms in the data of the new selection behavior.

The categorized first term information may further include category information of an item associated with the first term, and clustering unit 403 may further include:

a first determination sub-unit 4034 configured to determine whether the modified search phrase is an item name;

a second category determination sub-unit 4035 configured to, if the modified search phrase is an item name, determine a category of the item as a category of the corresponding target terms; and

a second category clustering sub-unit 4036 configured to, if the category of the target terms belongs to a category of the item associated with the first term, cluster the target terms and the first term into the same category.

In addition, the clustering unit 403 may be further configured to, if the modified search phrase is not an item name, determine whether a target term in the selection behavior data of the new search result can be clustered with the first term into the same category; and if yes, determine that the modified search phrase is clustered with the first term into the same category.

In some embodiments, the system 400 may further include a sequence information determination unit 405 configured to, when the operational behavior data of the user within the subsequent time period is collected, determine a sequence of occurrence of operation steps of the operational behavior data, as a clustering factor based on which the target terms are clustered.

FIG. 5 is a block diagram illustrating a system 500 for item search, consistent with exemplary embodiments of the present disclosure. System 500 may be a device for item search, such as a mobile phone, a computing device, a tablet computer, a mobile multimedia playback device, a smart watch, and etc. System 500 may include a number of components, some of which may be optional. The components in FIG. 5 may be arranged in another order. System 500 may, for example, a processing unit 506 and a memory 507. Memory 507 may be a non-transitory computer-readable storage medium storing instructions that, when executed by processing unit 506, cause one or more components of system 500 to perform the steps and methods described in this disclosure. System 500 may include functional modules implemented by the processing unit 506 and the memory 507, including, e.g., an associated relationship storage unit 501, a first search phrase receiving unit 502, a determination unit 503, a candidate term providing unit 504, and a search result providing unit 505. System 500 and system 400 may be integrated in one device or system using the same processor and/or memory. Association relationship storage unit 501, first search phrase receiving unit 502, determination unit 503, candidate term providing unit 504, and/or search result providing unit 505 refer to or correspond to blocks of software code stored on memory 507. The processing unit 506 can execute the blocks of software code and perform the functions corresponding to the functional modules. The steps below are related to corresponding methods described above, and some details are not repeated.

Association relationship storage unit 501 may be configured to pre-store a first term and associated a second term.

First search phrase receiving unit 502 may be configured to receive a first search phrase.

Determination unit 503 may be configured to determine whether there is a target first term associated with the first search phrase.

Candidate term providing unit 504 may be configured to, if there is the target first term, provide a second term associated with the target first term as a candidate term.

Search result providing unit 505 may be configured to, when a candidate term is selected, determine the candidate term as a second search phrase, and provide a search result associated with the second search phrase.

The pre-stored information may further include a display copy corresponding to the associated second term, and candidate term providing unit 504 may be further configured to provide a display copy corresponding to the second term associated with the target first term.

Candidate term providing unit 504 may be further configured to display the representative picture and the text description of the same second term in the same position in the form of flip display or other display methods.

As described above, it is possible to pre-establish and store an association relationship between a first term and a second term. In this way, after a user performs a search operation and inputs a first search phrase, it is possible to determine whether there is a first term corresponding to the first search phrase. If yes, it is possible to provide the user with a second term associated with the first term for the user to make a selection, so that the user can use the second term to initiate a search to obtain a higher-quality search result. The disclosed methods and devices can also increase the search efficiency and reduce the operation path of the user.

Another aspect of the disclosure is directed to a non-transitory computer-readable storage medium storing instructions which, when executed, cause one or more processors to perform the methods, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

It can be known through the above description of the implementation manners that it is apparent to those skilled in the art that the present disclosure may be accomplished by software plus a necessary universal hardware platform. Based on such an understanding, the above technical solution of the present disclosure or the part that makes contributions to the prior art can be substantially embodied in the form of a software product. The computer software product may be stored in a storage medium such as a ROM/RAM, a magnetic disk, or an optical disk, and include several instructions to instruct a computer device (which may be a personal computer, a server, a network device or the like) to perform the method as described in the embodiments of the present disclosure or in some parts of the embodiments.

The embodiments in the specification are described in a progressive manner, mutual reference can be made to the same or similar parts between the embodiments, and each embodiment focuses on describing differences between the embodiment and other embodiments. In particular, for systems or system embodiments, the description is relatively simple as it is basically similar to the process embodiments; please refer to the description of the process embodiment for related content. The systems and system embodiments described above are merely schematic, in which the units described as separate parts may or may not be physically separated, and the parts displayed as units may or may not be physical units, which may be located in the same position, or may be distributed onto a plurality of network units. It is possible to select some or all of the modules according to actual needs to achieve the objectives of the solutions of the embodiments. Those of ordinary skill in the art can understand and implement the present disclosure without making any creative efforts.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present disclosure. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for item search. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An item search method, comprising:
storing one or more first terms and associated one or more second terms;
receiving a first search phrase;
determining a target first term of the one or more first terms, the target first term associated with the first search phrase;
providing a second term associated with the target first term as a candidate term; and
when a candidate term is selected by a user, determining the candidate term as a second search phrase, and providing a search result associated with the second search phrase.

2. The method according to claim 1, further comprising storing a display copy corresponding to the associated one or more second terms, wherein providing the second term associated with the target first term as the candidate term further comprises providing a display copy corresponding to the second term.

3. The method according to claim 2, wherein:
the display copy comprises a representative picture and a text description; and
providing the second term associated with the target first term as the candidate term comprises displaying a representative picture and a text description of the second term in the same position in a form of flip display.

4. A method for establishing a term association relationship, comprising:
receiving a search phrase input by a user;
determining whether the search phrase matches a first term;
if the determination is yes, collecting operational behavior data of the user within a subsequent preset time period, wherein the first term is categorized;
extracting one or more target terms in the operational behavior data;
clustering the one or more target terms according to relations with the first term; and
determining a target term that can be clustered with the first term as a second term associated with the first term.

5. The method according to claim 4, wherein:
collecting the operational behavior data of the user within the subsequent preset time period comprises collecting data of selecting one or more items in a search result by the user within the subsequent preset time period; and
extracting the one or more target terms in the operational behavior data within the preset time period comprises extracting, from description information of the items selected by the user, one or more subjects of item names as the target terms in the operational behavior data.

6. The method according to claim 5, wherein:
the categorized first term comprises category information of an item associated with the first term; and
clustering the one or more target terms according to the relations with the first term comprises:
determining a selected target item corresponding to the operational behavior data,
determining a category of the selected target item as a category of the corresponding target terms, and
if the category of the target terms belongs to a category of the item associated with the first term, clustering the target terms and the first term into the same category.

7. The method according to claim 4, wherein:
collecting the operational behavior data of the user within the subsequent preset time period comprises collecting behavior data in a new search initiated by the user after modifying the search phrase within the subsequent preset time period, and behavior data of making a new selection on items of a new search result; and
extracting the one or more target terms in the operational behavior data within the preset time period comprises:
determining the modified search phrase as a target term in the data of the new search behavior, and
extracting, from description information of items selected from the new search result, one or more subjects of item names as target terms in the data of the new selection behavior.

8. The method according to claim 7, wherein:
the categorized first term comprises category information of an item associated with the first term; and
clustering the one or more target terms according to relations with the first term comprises:
determining whether the modified search phrase is an item name;
if the modified search phrase is an item name, determining a category of the item name as a category of the corresponding target term; and
if the category of the corresponding target term belongs to a category of the item associated with the first term, clustering the target term and the first term into the same category.

9. The method according to claim 8, further comprising:
if the modified search phrase is not an item name, determining whether a target term in the data of the selection behavior of the new search result can be clustered with the first term into the same category; and
if the target term in the data of the selection behavior of the new search result can be clustered with the first term into the same category, clustering the modified search phrase with the first term into the same category.

10. The method according to claim 4, wherein collecting the operational behavior data of the user within the subsequent preset time period comprises determining a sequence of occurrence of operation steps of the operational behavior data, as a clustering factor when the target terms corresponding to the operation steps are clustered.

11. An item search apparatus, comprising:
an association relationship storage unit configured to store one or more first terms and associated one or more second terms;
a first search phrase receiving unit configured to receive a first search phrase;
a determination unit configured to determine a target first term of the one or more first terms associated with the first search phrase;
a candidate term providing unit configured to provide a second term associated with the target first term as a candidate term; and
a search result providing unit configured to, when a candidate term is selected by a user, determine the candidate term as a second search phrase, and provide a search result associated with the second search phrase.

12. The apparatus according to claim 11, further comprising storing a display copy corresponding to the associated second term, wherein the candidate term providing unit is further configured to provide a display copy corresponding to the second term.

13. The apparatus according to claim 12, wherein the candidate term providing unit is further configured to display a representative picture and a text description of the second term in the same position in a form of flip display.

14. An apparatus for establishing a term association relationship, comprising:
an operational behavior data collection unit configured to, when a search phrase input by a user matches with a first term, collect operational behavior data of the user within a subsequent preset time period, wherein the first term is categorized;
a target term extraction unit configured to extract one or more target terms in the operational behavior data;
a clustering unit configured to cluster the target terms according to relations with the first term; and
an association relationship determination unit configured to determine a target term that can be clustered with the first term as a second term associated with the first term.

15. The apparatus according to claim 14, wherein:
the operational behavior data collection unit is further configure to collect data of selecting one or more items in a search result by the user within the subsequent preset time period; and
the target term extraction unit is further configured to extract, from description information of the items selected by the user, one or more subjects of item names as the target terms in the operational behavior data.

16. The apparatus according to claim 15, wherein:
the categorized first term comprises information of an item associated with the first term; and
the clustering unit comprises:
a first item determination sub-unit configured to determine a selected target item corresponding to the operational behavior data;
a first category determination sub-unit configured to determine a category of the target item as a category of the corresponding target terms; and
a first category judgment sub-unit configured to, if the category of the target terms belongs to a category of the item associated with the first term, cluster the target terms and the first term into the same category.

17. The apparatus according to claim 14, wherein:
the operational behavior data collection unit is further configured to collect behavior data in a new search initiated by the user after modifying the search phrase within the subsequent preset time period, and behavior data of making a new selection on items in a new search result; and
the target term extraction unit is further configured to:
determine the modified search phrase as a target term in the data of the new search behavior, and
extract, from description information of the items selected from the new search result, one or more subjects of item names as target terms in the data of the new selection behavior.

18. The apparatus according to claim 17, wherein:
the categorized first term comprises information of an item associated with the first term; and
the clustering unit comprises:
a first determination sub-unit configured to determine whether the modified search phrase is an item name;
a second category determination sub-unit configured to, if the modified search phrase is an item name, determine a category of the item as a category of the corresponding target term; and
a second category clustering sub-unit configured to, if the category of the corresponding target term belongs to a category of the item associated with the first term, cluster the target term and the first term into the same category.

19. The apparatus according to claim 18, wherein the clustering unit is further configured to:
if the modified search phrase is not an item name, determine whether a target term in the data of the selection behavior of the new search result can be clustered with the first term into the same category, and
if the target term in the data of the selection behavior of the new search result can be clustered with the first term into the same category, cluster the modified search phrase with the first term into the same category.

20. The apparatus according to claim 14, further comprising:
a sequence information determination unit configured to determine a sequence of occurrence of operation steps of the operational behavior data, as a clustering factor when the target terms are clustered.
